(19) United States
(12) Patent Application Publication
(10) Pub. No.: US 2022/0301470 A1
(43) Pub. Date: Sep. 22, 2022

(54) METHOD AND DEVICE FOR GAMMA DEBUGGING

(71) Applicant: CHONGQING KONKA PHOTOELECTRIC TECHNOLOGY RESEARCH INSTITUTE CO., LTD., Chongqing (CN)

(72) Inventors: Jiang CAO, Chongqing (CN); Yongchao JIANG, Chongqing (CN)

(21) Appl. No.: 17/714,566

(22) Filed: Apr. 6, 2022

Related U.S. Application Data
(63) Continuation of application No. PCT/CN2021/081779, filed on Mar. 19, 2021.

(51) Int. Cl. G09G 3/00; G09G 3/20

(52) U.S. Cl. CPC G09G 3/006; G09G 3/2003; G09G 2320/0626; G09G 2320/0673

(57) ABSTRACT

A method for Gamma debugging and a device for Gamma debugging are provided. The method for Gamma debugging includes the following. A display brightness of a device for Gamma debugging is adjusted to a preset brightness. A display chromaticity of the device for Gamma debugging is adjusted.

### CROSS-REFERENCE TO RELATED APPLICATION(S)

This application is a continuation of International Application No. PCT/CN2021/081779, filed Mar. 19, 2021, the disclosure of which is hereby incorporated by reference in its entirety.

### TECHNICAL FIELD

This disclosure relates to the field of display technology, and particularly to a method for Gamma debugging and a device for Gamma debugging.

### BACKGROUND

Micro light-emitting diode (LED) has advantages of good stability, small size, power saving, wide color gamut, long lifetime, etc., and also inherits advantages of an LED such as low power, high color saturation, fast response speed, and strong contrast. In recent years, Micro LED products have emerged. However, there is no mature method for Gamma debugging of the Micro LED product in the field. The existing method for Gamma debugging of the Micro LED product generally can only be implemented by manually adjusting to drive adjustment of a register of an integrated circuit (IC), which leads to reduction in a display efficiency of the product and results in a relatively low user visual experience.

### SUMMARY

The disclosure provides a device for Gamma debugging. The device for Gamma debugging includes a display panel, at least one processor, and a memory. The at least one processor is coupled with the display panel. The memory is coupled with the at least one processor and the display panel and stores computer-executed instructions which, when executed by the at least one processor, cause the at least one processor to: adjust a display brightness of the display panel to a preset brightness; and adjust a display chromaticity of the display panel.

The disclosure also provides a method for Gamma debugging. The method for Gamma debugging includes the following. A display brightness of a device for Gamma debugging is adjusted to a preset brightness. A display chromaticity of the device for Gamma debugging is adjusted.

The disclosure also provides a non-transitory computer-readable storage medium. The non-transitory computer-readable storage medium stores computer-executed instructions which, when executed by a processor, cause the processor to implement the method for Gamma debugging of the disclosure.

### BRIEF DESCRIPTION OF THE DRAWINGS

In order to describe technical solutions of implementations of the disclosure more clearly, the following will give a brief description of accompanying drawings used for describing the implementations. Apparently, accompanying drawings described below are merely some implementations. Those of ordinary skill in the art can also obtain other accompanying drawings based on these accompanying drawings without creative efforts.

FIG. 1 is a schematic structural diagram illustrating a device for Gamma debugging provided in implementations of the disclosure.

FIG. 2 is a schematic structural diagram illustrating a brightness adjustment module of the device for Gamma debugging illustrated in FIG. 1.

FIG. 3 is a schematic structural diagram illustrating a chromaticity adjustment module of the device for Gamma debugging illustrated in FIG. 1.

FIG. 4 is a color space distribution diagram of the device for Gamma debugging illustrated in FIG. 1.

FIG. 5 is a schematic flowchart illustrating a method for Gamma debugging provided in implementations of the disclosure.

FIG. 6 is a schematic flowchart illustrating operations at S10 of the method for Gamma debugging illustrated in FIG. 5.

FIG. 7 is a schematic flowchart illustrating operations at S20 of the method for Gamma debugging illustrated in FIG. 5.

FIG. 8 is a schematic diagram illustrating a hardware structure of a device for Gamma debugging provided in implementations of the disclosure.

### DESCRIPTION OF REFERENCE NUMERALS

100, 200—the device for Gamma debugging; 110—the brightness adjustment module; 111—a brightness determining unit; 112—a brightness calculation unit; 113—a brightness debugging unit; 120—the chromaticity adjustment module; 121—an obtaining unit; 122—a chromaticity-coordinate determining unit; 123—a chromaticity calculation unit; 124—a chromaticity debugging unit; 201—a processor; 202—a memory; 203—a bus; S10-S20—operations of the method for Gamma debugging; S11-S13—operations of a brightness adjustment method; and S21-S24—operations of a chromaticity adjustment method.

### DETAILED DESCRIPTION

In order to facilitate understanding of the disclosure, the disclosure will be fully described below with reference to related drawings. The accompanying drawings illustrate exemplary implementations of the disclosure. However, the disclosure can be implemented in many different forms and is not limited to implementations described herein. Rather, these implementations are provided for a more thorough and comprehensive understanding of disclosed contents of the disclosure.

Unless otherwise defined, all technical and scientific terms herein have the same meaning as commonly understood by one of ordinary skill in the technical field to which the disclosure belongs. The terms in the specification of the disclosure are merely for the purpose of describing implementations of the disclosure, which are not intended to limit the disclosure.

Micro light-emitting diode (LED) has advantages of good stability, small size, power saving, wide color gamut, long lifetime, etc., and also inherits advantages of an LED such as low power, high color saturation, fast response speed, and strong contrast. In recent years, Micro LED products have emerged. However, there is no mature method for Gamma debugging of the Micro LED product in the field. The existing method for Gamma debugging of the Micro LED product generally can only be implemented by manually adjusting to drive adjustment of a register of an integrated circuit (IC), which leads to reduction in a display efficiency of the product and results in a relatively low user visual experience.

Based on the above, the disclosure aims to provide solutions that can solve the above technical problem, to realize automatic Gamma debugging of the Micro LED product, so that an efficiency of Gamma debugging of the Micro LED product can be improved effectively. The details will be described in the following implementations.

According to implementations of the disclosure, a device for Gamma debugging is provided. The device for Gamma debugging includes a display panel, at least one processor, and a memory. The at least one processor is coupled with the display panel. The memory is coupled with the at least one processor and the display panel and stores computer-executed instructions which, when executed by the at least one processor, cause the at least one processor to: adjust a display brightness of the display panel to a preset brightness; and adjust a display chromaticity of the display panel.

In some implementations, the at least one processor configured to adjust the display brightness of the display panel to the preset brightness is configured to: determine a maximum brightness of a white screen of the device for Gamma debugging, to ensure that the white screen has the preset brightness; obtain target brightness values corresponding to different gray levels according to the maximum brightness determined; and adjust the display brightness to the preset brightness according to the target brightness values corresponding to the different gray levels.

In some implementations, the at least one processor configured to obtain the target brightness values corresponding to the different gray levels according to the maximum brightness determined is configured to: calculate the target brightness values corresponding to the different gray levels according to a gray level, a Gamma value, a relationship formula between the Gamma value and the gray level, and the maximum brightness determined.

In some implementations, the at least one processor configured to adjust the display chromaticity of the display panel is configured to: obtain a chromaticity coordinate of the white screen of the device for Gamma debugging; obtain a distribution of the chromaticity coordinate corresponding to the gray level in a color space; determine, according to the distribution of the chromaticity coordinate corresponding to the gray level in the color space, a color that affects a white coordinate; and adjust a chromaticity corresponding to the gray level according to the color that affects the white coordinate.

In some implementations, the at least one processor configured to adjust the display chromaticity of the display panel is configured to: obtain a chromaticity coordinate of a white screen of the device for Gamma debugging; obtain a distribution of the chromaticity coordinate corresponding to a gray level in a color space; determine, according to the distribution of the chromaticity coordinate corresponding to the gray level in the color space, a color that affects a white coordinate; and adjust a chromaticity corresponding to the gray level according to the color that affects the white coordinate.

In some implementations, the at least one processor configured to obtain the distribution of the chromaticity coordinate corresponding to the gray level in the color space is configured to: obtain the distribution of the chromaticity coordinate corresponding to the gray level in the color space according to a difference between the obtained chromaticity coordinate of the white screen and a preset chromaticity coordinate of the white screen.

In some implementations, the at least one processor configured to adjust the chromaticity corresponding to the gray level according to the color that affects the white coordinate is configured to: adjust a brightness value of the color in the white screen according to the color that affects the white coordinate, and change a ratio of the color in three primary colors.

In some implementations, the color space includes a blue area, a red area, and a green area.

In some implementations, the chromaticity coordinate is determined to be in the blue area when an x value of the chromaticity coordinate is less than 0.32 and a y value of the chromaticity coordinate is less than 0.32, and the white coordinate is affected by blue.

In some implementations, the chromaticity coordinate is determined to be in the red area when an x value of the chromaticity coordinate is greater than 0.32 and a y value of the chromaticity coordinate is less than 0.55, and the white coordinate is affected by red.

In some implementations, the chromaticity coordinate is determined to be in the green area when an x value of the chromaticity coordinate is less than 0.32 and a y value of the chromaticity coordinate is greater than 0.32, and the white coordinate is affected by green.

In the device for Gamma debugging, the brightness and the chromaticity are adjusted respectively. Therefore, the device for Gamma debugging of the disclosure can realize automatic Gamma debugging of the Micro LED product, thereby improving effectively the efficiency of the Gamma debugging for the Micro LED product.

According to implementations of the disclosure, a method for Gamma debugging is provided. The method for Gamma debugging includes the following. A display brightness of a device for Gamma debugging is adjusted to a preset brightness. A display chromaticity of the device for Gamma debugging is adjusted.

In some implementations, adjusting the display brightness of the device for Gamma debugging to the preset brightness includes: determining a maximum brightness of a white screen of the device for Gamma debugging; obtaining target brightness values corresponding to different gray levels according to the maximum brightness determined; and adjusting the display brightness of the device for Gamma debugging to the preset brightness according to the target brightness values corresponding to the different gray levels.

In some implementations, obtaining the target brightness values corresponding to the different gray levels according to the maximum brightness determined includes: calculating the target brightness values corresponding to the different gray levels according to a gray level, a Gamma value, a relationship formula between the Gamma value and the gray level, and the maximum brightness determined.

In some implementations, adjusting the display chromaticity of the device for Gamma debugging includes: obtaining a chromaticity coordinate of the white screen of the device for Gamma debugging; determining a distribution of the chromaticity coordinate corresponding to the gray level in a color space; determining, according to the distribution of the chromaticity coordinate corresponding to the gray level in the color space, a color that affects a white coordinate; and adjusting a chromaticity corresponding to the gray level according to the color that affects the white coordinate.

In some implementations, adjusting the display chromaticity of the device for Gamma debugging includes: obtaining a chromaticity coordinate of a white screen of the device for Gamma debugging; determining a distribution of the chromaticity coordinate corresponding to a gray level in a color space; determining, according to the distribution of the chromaticity coordinate corresponding to the gray level in the color space, a color that affects a white coordinate; and adjusting a chromaticity corresponding to the gray level according to the color that affects the white coordinate.

In some implementations, determining the distribution of the chromaticity coordinate corresponding to the gray level in the color space includes: determining the distribution of the chromaticity coordinate corresponding to the gray level in the color space according to a difference between the obtained chromaticity coordinate of the white screen and a preset chromaticity coordinate of the white screen.

In some implementations, adjusting the chromaticity corresponding to the gray level according to the color that affects the white coordinate includes: adjusting a brightness value of the color in the white screen according to the color that affects the white coordinate, and changing a ratio of the color in three primary colors.

In some implementations, the color space includes a blue area, a red area, and a green area. The chromaticity coordinate is determined to be in the blue area when an x value of the chromaticity coordinate is less than 0.32 and a y value of the chromaticity coordinate is less than 0.32, and the white coordinate is affected by blue. The chromaticity coordinate is determined to be in the red area when the x value is greater than 0.32 and the y value is less than 0.55, and the white coordinate is affected by red. The chromaticity coordinate is determined to be in the green area when the x value is less than 0.32 and the y value is greater than 0.32, and the white coordinate is affected by green.

In the method for Gamma debugging, the brightness and the chromaticity are adjusted respectively. Therefore, the method for Gamma debugging of the disclosure can realize automatic Gamma debugging of the Micro LED product, thereby improving effectively the efficiency of the Gamma debugging of the Micro LED product.

According to implementations of the disclosure, a non-transitory computer-readable storage medium is provided. The non-transitory computer-readable storage medium stores computer-executed instructions which, when executed by a processor, cause the processor to implement the method for Gamma debugging of the disclosure.

A related circuit structure of a device for Gamma debugging and a specific process of a related method for Gamma debugging will be described in detail in the solutions of the disclosure.

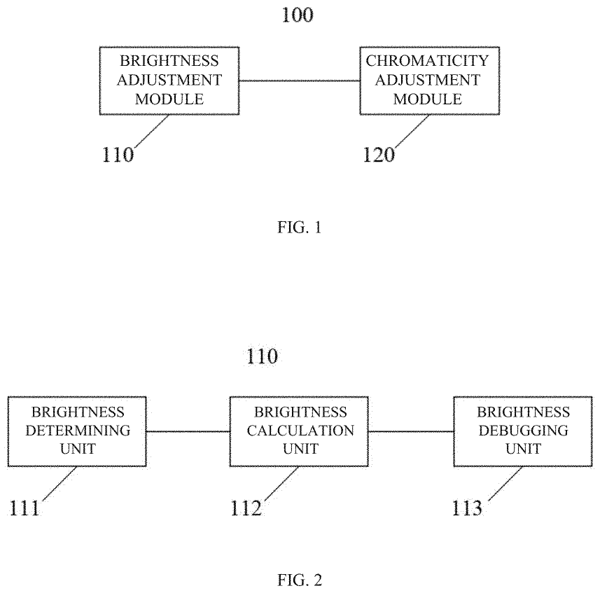

Referring to FIG. 1, FIG. 1 is a schematic structural diagram illustrating a device for Gamma debugging provided in implementations of the disclosure. As illustrated in FIG. 1, the disclosure provides a device 100 for Gamma debugging. The device 100 for Gamma debugging includes a brightness adjustment module 110 and a chromaticity adjustment module 120 electrically coupled with the brightness adjustment module 110. The brightness adjustment module 110 is configured to adjust a display brightness of a display panel to a preset brightness. The chromaticity adjustment module 120 is configured to adjust a display chromaticity of the display panel. It can be understood that, in some implementations, the display panel may be a Micro LED display panel, which is not limited herein.

Referring to FIG. 2, FIG. 2 is a schematic structural diagram illustrating the brightness adjustment module 110 of the device for Gamma debugging illustrated in FIG. 1. As illustrated in FIG. 2, the brightness adjustment module 110 includes a brightness determining unit 111, a brightness calculation unit 112, and a brightness debugging unit 113. The brightness determining unit 111 is electrically coupled with the brightness calculation unit 112, and the brightness calculation unit 112 is electrically coupled with the brightness debugging unit 113. That is, the brightness calculation unit 112 is electrically coupled with the brightness determining unit 111 and the brightness debugging unit 113 respectively.

In this implementation, the brightness determining unit 111 is configured to determine a maximum brightness of a white screen of the device 100 for Gamma debugging, to ensure that the white screen has a preset brightness. The brightness determining unit 111 is configured to transmit the determined maximum brightness to the brightness calculation unit 112.

The brightness calculation unit 112 is configured to calculate target brightness values corresponding to different gray levels. Specifically, the brightness calculation unit 112 is configured to calculate the target brightness values corresponding to the different gray levels according to a gray level, a Gamma value, a relationship formula between the Gamma value and the gray level, and the maximum brightness determined by the brightness determining unit 111. A calculation formula of the target brightness value (i.e., the relationship formula between the Gamma value and the gray level) is expressed as

$$L = L {max ( \frac{x}{255} )}^{r} ,$$

where L represents the target brightness value, Lmax represents the maximum brightness, x represents the gray level, and r represents the Gamma value. In practical applications, a display brightness is generally divided into gray levels of 0˜255. After the maximum brightness is determined, a black screen with the minimum brightness is calculated according to a brightness of 0 gray level. A target brightness value corresponding to any gray level can be calculated according to the relationship formula between the Gamma value and the gray level, to obtain target brightness values corresponding to different gray levels of 0˜255. The obtained target brightness values corresponding to the different gray levels of 0˜255 are transmitted to the brightness debugging unit 113.

The brightness debugging unit 113 is configured to adjust a display brightness of the device 100 for Gamma debugging to the preset brightness according to the target brightness values corresponding to the different gray levels calculated by the brightness calculation unit 112. When performing Gamma debugging on the display brightness of the device 100 for Gamma debugging, the debugging is generally performed according to a standard Gamma curve 2.2. When debugging according to the Gamma curve 2.2, the progress of a brightness of each gray level is equidistant, which can better adapt to visual characteristics of human eyes.

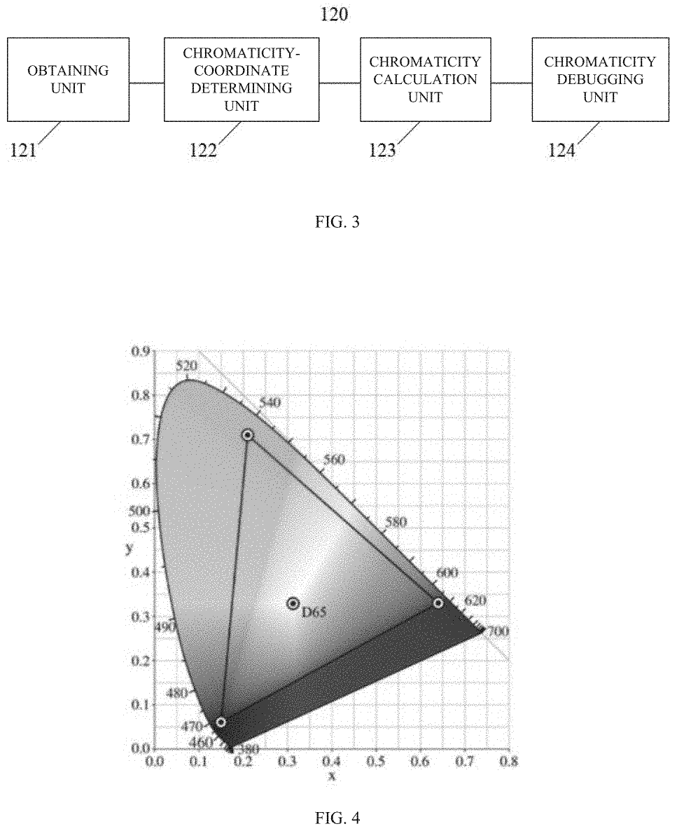

Referring to FIG. 3, FIG. 3 is a schematic structural diagram illustrating the chromaticity adjustment module 120 of the device for Gamma debugging 100 illustrated in FIG. 1. As illustrated in FIG. 3, the chromaticity adjustment module 120 includes an obtaining unit 121, a chromaticity-coordinate determining unit 122, a chromaticity calculation unit 123, and a chromaticity debugging unit 124. The obtaining unit 121 is electrically coupled with the chromaticity-coordinate determining unit 122, the chromaticity-coordinate determining unit 122 is electrically coupled with the chromaticity calculation unit 123, and the chromaticity calculation unit 123 is electrically coupled with the chromaticity debugging unit 124.

In this implementation, the obtaining unit 121 is configured to obtain a chromaticity coordinate of the white screen of the device 100 for Gamma debugging, and transmit the obtained chromaticity coordinate of the device 100 for Gamma debugging to the chromaticity-coordinate determining unit 122.

The chromaticity-coordinate determining unit 122 is configured to obtain a distribution of the chromaticity coordinate corresponding to the gray level in a color space according to a difference between the chromaticity coordinate of the white screen of the device 100 for Gamma debugging obtained by the obtaining unit 121 and a preset chromaticity coordinate of the white screen of the device 100 for Gamma debugging. Specifically, referring to a color space illustrated in FIG. 4, the chromaticity-coordinate determining unit 122 is configured to compare the chromaticity coordinate of the white screen of the device 100 for Gamma debugging obtained by the obtaining unit 121 with the preset chromaticity coordinate, to obtain the distribution of the chromaticity coordinate corresponding to the gray level in the color space, and configured to transmit the distribution of the chromaticity coordinate corresponding to the gray level in the color space to the chromaticity calculation unit 123. The color space is composed of three primary colors of red, green, and blue (RGB).

The chromaticity calculation unit 123 is configured to determine, according to the distribution of the chromaticity coordinate corresponding to the gray level in the color space obtained by the chromaticity-coordinate determining unit 122, a color that affects a white coordinate. The chromaticity calculation unit 123 is configured to transmit the color that affects the white coordinate to the chromaticity debugging unit 124. Specifically, in order to accurately determine which color has a greater impact on the white coordinate, the chromaticity coordinate can be divided into three areas: a blue area, a red area, and a green area. If an x value of the chromaticity coordinate is less than 0.32 (x<0.32) and a y value of the chromaticity coordinate is less than 0.32 (y<0.32), the chromaticity coordinate is determined to be the blue area, and the white coordinate is affected by blue. If an x value of the chromaticity coordinate is greater than 0.32 (x>0.32) and a y value of the chromaticity coordinate is less than 0.55 (y<0.55), the chromaticity coordinate is determined to be the red area, and the white coordinate is affected by red. If an x value of the chromaticity coordinate is less than 0.32 (x<0.32) and a y value of the chromaticity coordinate is greater than 0.32 (y>0.32), the chromaticity coordinate is determined to be the green area, and the white coordinate is affected by green. As illustrated in FIG. 4, the white coordinate for example is (0.282, 0.282), and the white coordinate is mainly affected by blue.

The chromaticity debugging unit 124 is configured to adjust a chromaticity corresponding to the gray level. Specifically, the chromaticity debugging unit 124 is configured to adjust a brightness value of the color in the white screen according to the color that affects the white coordinate obtained by the chromaticity calculation unit 123, and change a ratio of the color in RGB. For ease of understanding and explanation, for example, adjustment of the brightness value of blue in the white screen will be described in detail. When adjusting, first, a reduction adjustment with an accuracy of 1% of a Gamma register is performed, to adjust a value of blue that has a greater impact on the white coordinate in the Gamma register corresponding to the gray level, and then, the brightness value of blue is reduced gradually until a difference between each measured chromaticity coordinate (x, y) and a set chromaticity coordinate of the white screen of the device 100 for Gamma debugging is within ±0.01. Once the difference between the measured chromaticity coordinate (x, y) and the set chromaticity coordinate of the white screen of the device 100 for Gamma debugging is less than 1%, stop the adjustment with the accuracy of 1%, and an adjustment with an accuracy of 1/1000 is performed until an error is within ±0.003.

Referring to FIG. 5, FIG. 5 is a schematic flowchart illustrating a method for Gamma debugging provided in implementations of the disclosure. The method for Gamma debugging is for debugging a display device of implementations described with reference to FIG. 1 to FIG. 3, to realize automatic gamma debugging, thereby improving effectively an efficiency of Gamma debugging of the Micro LED product. As illustrated in FIG. 5, the method for Gamma debugging at least includes the following.

At S10, a brightness of a device 100 for Gamma debugging is adjusted to a preset brightness.

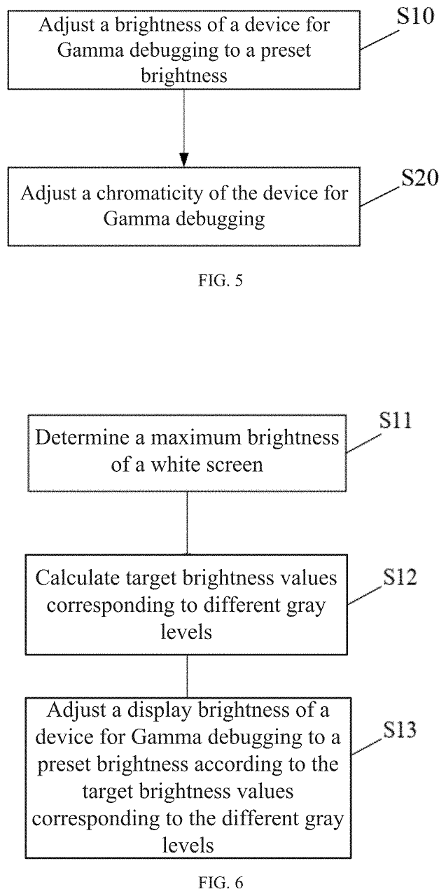

In this implementation, referring to FIG. 6, adjusting the brightness of the device 100 for Gamma debugging to the preset brightness at least includes the following. It can be understood that, the preset brightness varies with different products. For the sake of brevity, the preset brightness is not further limited in implementations of the disclosure.

At S11, a maximum brightness of a white screen is determined.

Specifically, the brightness determining unit 111 determines the maximum brightness of the white screen of the device 100 for Gamma debugging, to ensure that the white screen has the preset brightness, and transmits the determined maximum brightness to the brightness calculation unit 112.

At S12, target brightness values corresponding to different gray levels are calculated.

Specifically, the brightness calculation unit 112 obtains the target brightness values corresponding to the different gray levels based on the maximum brightness. Specifically, the brightness calculation unit 112 calculates the target brightness values corresponding to the different gray levels according to a gray level, a Gamma value, a relationship formula between the Gamma value and the gray level, and the maximum brightness determined by the brightness determining unit 111. A calculation formula of the target brightness value (i.e., the relationship formula between the Gamma value and the gray level) is expressed as

$$L = L {max ( \frac{x}{255} )}^{r} ,$$

where L represents the target brightness value, Lmax represents the maximum brightness, x represents the gray level, and r represents the Gamma value. In practical applications, a display brightness is generally divided into gray levels of 0˜255. After the maximum brightness is determined, a black screen with the minimum brightness is calculated according to a brightness of 0 gray level. A target brightness value corresponding to any gray level can be calculated according to the relationship formula between the Gamma value and the gray level, to obtain target brightness values corresponding to different gray levels of 0˜255. The obtained target brightness values corresponding to the different gray levels of 0˜255 are transmitted to the brightness debugging unit 113.

At S13, a display brightness of the device 100 for Gamma debugging is adjusted to the preset brightness according to the target brightness values corresponding to the different gray levels.

Specifically, the brightness debugging unit 113 adjusts the display brightness of the device 100 for Gamma debugging according to the target brightness values corresponding to the different gray levels of 0˜255 calculated by the brightness calculation unit 112. When performing Gamma debugging on the display brightness of the device 100 for Gamma debugging, the debugging is generally performed according to a standard Gamma curve 2.2. When debugging according to the Gamma curve 2.2, the progress of a brightness of each gray level is equidistant, which can better adapt to visual characteristics of human eyes.

At S20, a chromaticity of the device 100 for Gamma debugging is adjusted.

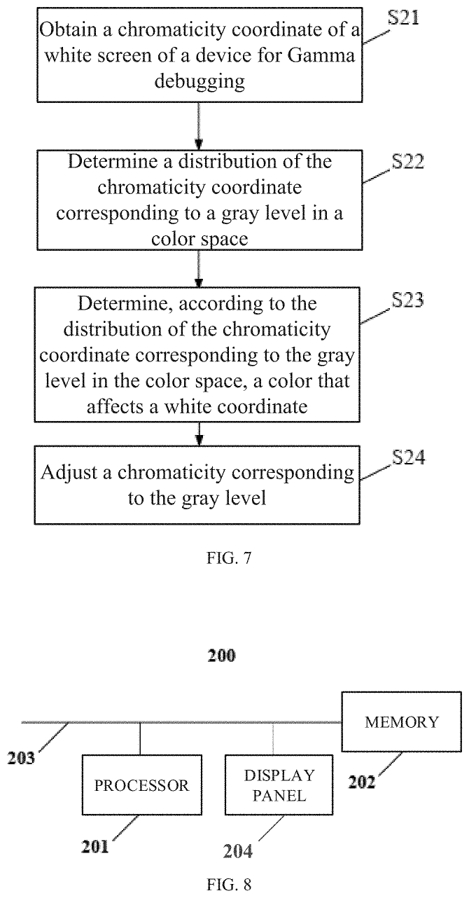

In this implementation, referring to FIG. 7, adjusting the chromaticity of the device 100 for Gamma debugging at least includes the following.

At S21, a chromaticity coordinate of the white screen of the device 100 for Gamma debugging is obtained.

Specifically, the obtaining unit 121 obtains the chromaticity coordinate of the white screen of the device 100 for Gamma debugging, and transmits the obtained chromaticity coordinate of the device 100 for Gamma debugging to the chromaticity-coordinate determining unit 122.

At S22, a distribution of the chromaticity coordinate corresponding to the gray level in a color space is determined.

Specifically, the chromaticity-coordinate determining unit 122 obtains the distribution of the chromaticity coordinate corresponding to the gray level in the color space according to a difference between the chromaticity coordinate of the white screen of the device 100 for Gamma debugging obtained by the obtaining unit 121 and a preset chromaticity coordinate of the white screen of the device 100 for Gamma debugging. In this implementation, referring to a color space illustrated in FIG. 4, the chromaticity-coordinate determining unit 122 compares the chromaticity coordinate of the white screen of the device 100 for Gamma debugging obtained by the obtaining unit 121 with the preset chromaticity coordinate, to obtain the distribution of the chromaticity coordinate corresponding to the gray level in the color space, and transmits the distribution of the chromaticity coordinate corresponding to the gray level in the color space to the chromaticity calculation unit 123. The color space is composed of three primary colors of red, green, and blue (RGB).

At S23, according to the distribution of the chromaticity coordinate corresponding to the gray level in the color space, a color that affects a white coordinate is determined.

In this implementation, the chromaticity calculation unit 123 determines, according to the distribution of the chromaticity coordinate corresponding to the gray level in the color space obtained by the chromaticity-coordinate determining unit 122, the color that affects the white coordinate. The chromaticity calculation unit 123 transmits the color to the chromaticity debugging unit 124. Specifically, in order to accurately determine which color has a greater impact on the white coordinate, the chromaticity coordinate can be divided into three areas: a blue area, a red area, and a green area. If an x value of the chromaticity coordinate is less than 0.32 (x<0.32) and a y value of the chromaticity coordinate is less than 0.32 (y<0.32), the chromaticity coordinate is determined to be the blue area, and the white coordinate is affected by blue. If an x value of the chromaticity coordinate is greater than 0.32 (x>0.32) and a y value of the chromaticity coordinate is less than 0.55 (y<0.55), the chromaticity coordinate is determined to be the red area, and the white coordinate is affected by red. If an x value of the chromaticity coordinate is less than 0.32 (x<0.32) and a y value of the chromaticity coordinate is greater than 0.32 (y>0.32), the chromaticity coordinate is determined to be the green area, and the white coordinate is affected by green. As illustrated in FIG. 4, the white coordinate for example is (0.282, 0.282), and the white coordinate is mainly affected by blue.

At S24, a chromaticity corresponding to the gray level is adjusted.

In this implementation, the chromaticity debugging unit 124 adjusts the chromaticity corresponding to the gray level. Specifically, the chromaticity debugging unit 124 adjusts a brightness value of the color that affects the white coordinate in the white screen according to the color that affects the white coordinate obtained by the chromaticity calculation unit 123, and changes a ratio of the color in RGB. For ease of understanding and explanation, for example, adjustment of the brightness value of blue in the white screen will be described in detail. When adjusting, first, a reduction adjustment with an accuracy of 1% of a Gamma register is performed, to adjust a value of blue that has a greater impact on the white coordinate in the Gamma register corresponding to the gray level, and then, the brightness value of blue is reduced gradually until a difference between each measured chromaticity coordinate (x, y) and a set chromaticity coordinate of the white screen of the device 100 for Gamma debugging is within ±0.01. Once the difference between the measured chromaticity coordinate (x, y) and the set chromaticity coordinate of the white screen of the device 100 for Gamma debugging is less than 1%, stop the adjustment with the accuracy of 1%, and an adjustment with an accuracy of 1/1000 is performed until an error is within ±0.003.

It can be understood that, after the white screen is finished, a brightness ratio of the white screen is fixed. The above operations are repeated for other gray levels until a chromaticity coordinate of each gray level reaches a predetermined target value.

In sum, according to the method for Gamma debugging of the disclosure, Gamma of a display device such as a Micro LED can be adjusted automatically, which can improve effectively an efficiency of Gamma debugging of the Micro LED product. Moreover, the method for Gamma debugging involves the adjustment of two aspects of brightness and chromaticity, which can realize display uniformity of the display device, thereby improving a display effect of the display device and a user visual experience.

The device for Gamma debugging of implementations of the disclosure can be used to execute the foregoing method implementations, and realizes similar implementation principles and similar technical effects, which will not be repeated in the implementations.

Referring to FIG. 8, FIG. 8 is a schematic diagram illustrating a hardware structure of a device for Gamma debugging provided in implementations of the disclosure. As illustrated in FIG. 8, a device 200 for Gamma debugging of implementations of the disclosure includes at least one processor 201 and a memory 202. The device 200 for Gamma debugging further includes at least one bus 203. The processor 201 is electrically coupled with the memory 202 via the bus 203. The device 200 for Gamma debugging may be a computer or a server, which is not limited in the disclosure. The device 200 for Gamma debugging further includes a display panel 204. The display panel may be a Micro LED display panel, which is not limited herein.

In a specific implementation process, the at least one processor 201 is configured to execute computer-executed instructions stored in the memory 202, to cause the at least one processor 201 to execute the method for Gamma debugging which is executed by the above device 200 for Gamma debugging.

For the specific implementation process of the processor 201 of implementations of the disclosure, reference may be made to the foregoing method implementations. The processor 201 realizes similar implementation principles and similar technical effects, which will not be repeated in the implementations.

It can be understood that, the processor 201 may be a central processing unit (CPU), and may also be other general-purpose processors, digital signal processors (DSP), application specific integrated circuits (ASIC), etc. The general-purpose processor may be a microprocessor or the processor may be any conventional processor or the like. The operations of the method of the disclosure may be directly embodied as being executed by a hardware processor, or being executed by a combination of software modules and hardware in a processor.

The memory 202 may be a high-speed random access memory (RAM) or a non-transitory memory.

The bus 203 may be an industry standard architecture (ISA) bus, a peripheral component interconnect (PCI) bus, an extended industry standard architecture (EISA) bus, or the like. For ease of representation, the bus 203 in the accompanying drawings of the disclosure is not limited to only one bus or one type of bus.

It should be understood that, applications of the disclosure are not limited to the above examples. Any modifications or equivalent substitutions made by those of ordinary skill in the art according to the above descriptions shall all be encompassed within the protection scope of the appended claims of the disclosure.

What is claimed is:

1. A device for Gamma debugging, comprising:
a display panel;
at least one processor, coupled with the display panel; and
a memory, coupled with the at least one processor and the display panel and storing computer-executed instructions which, when executed by the at least one processor, cause the at least one processor to:
adjust a display brightness of the display panel to a preset brightness; and
adjust a display chromaticity of the display panel.

2. The device for Gamma debugging of claim 1, wherein the at least one processor configured to adjust the display brightness of the display panel to the preset brightness is configured to:
determine a maximum brightness of a white screen of the device for Gamma debugging, to ensure that the white screen has the preset brightness;
obtain target brightness values corresponding to different gray levels according to the maximum brightness determined; and
adjust the display brightness to the preset brightness according to the target brightness values corresponding to the different gray levels.

3. The device for Gamma debugging of claim 2, wherein the at least one processor configured to obtain the target brightness values corresponding to the different gray levels according to the maximum brightness determined is configured to:
calculate the target brightness values corresponding to the different gray levels according to a gray level, a Gamma value, a relationship formula between the Gamma value and the gray level, and the maximum brightness determined.

4. The device for Gamma debugging of claim 2, wherein the at least one processor configured to adjust the display chromaticity of the display panel is configured to:
obtain a chromaticity coordinate of the white screen of the device for Gamma debugging;
obtain a distribution of the chromaticity coordinate corresponding to the gray level in a color space;
determine, according to the distribution of the chromaticity coordinate corresponding to the gray level in the color space, a color that affects a white coordinate; and
adjust a chromaticity corresponding to the gray level according to the color that affects the white coordinate.

5. The device for Gamma debugging of claim 1, wherein the at least one processor configured to adjust the display chromaticity of the display panel is configured to:
obtain a chromaticity coordinate of a white screen of the device for Gamma debugging;
obtain a distribution of the chromaticity coordinate corresponding to a gray level in a color space;
determine, according to the distribution of the chromaticity coordinate corresponding to the gray level in the color space, a color that affects a white coordinate; and
adjust a chromaticity corresponding to the gray level according to the color that affects the white coordinate.

6. The device for Gamma debugging of claim 5, wherein the at least one processor configured to obtain the distribution of the chromaticity coordinate corresponding to the gray level in the color space is configured to:
obtain the distribution of the chromaticity coordinate corresponding to the gray level in the color space according to a difference between the obtained chromaticity coordinate of the white screen and a preset chromaticity coordinate of the white screen.

7. The device for Gamma debugging of claim 5, wherein the at least one processor configured to adjust the chromaticity corresponding to the gray level according to the color that affects the white coordinate is configured to:
adjust a brightness value of the color in the white screen according to the color that affects the white coordinate, and change a ratio of the color in three primary colors.

8. The device for Gamma debugging of claim 5, wherein the color space comprises a blue area, a red area, and a green area.

9. The device for Gamma debugging of claim 8, wherein the chromaticity coordinate is determined to be in the blue area when an x value of the chromaticity coordinate is less than 0.32 and a y value of the chromaticity coordinate is less than 0.32, and the white coordinate is affected by blue.

10. The device for Gamma debugging of claim 8, wherein the chromaticity coordinate is determined to be in the red area when an x value of the chromaticity coordinate is greater than 0.32 and a y value of the chromaticity coordinate is less than 0.55, and the white coordinate is affected by red.

11. The device for Gamma debugging of claim 8, wherein the chromaticity coordinate is determined to be in the green area when an x value of the chromaticity coordinate is less than 0.32 and a y value of the chromaticity coordinate is greater than 0.32, and the white coordinate is affected by green.

12. A method for Gamma debugging, comprising:
adjusting a display brightness of a device for Gamma debugging to a preset brightness; and
adjusting a display chromaticity of the device for Gamma debugging.

13. The method for Gamma debugging of claim 12, wherein adjusting the display brightness of the device for Gamma debugging to the preset brightness comprises:
determining a maximum brightness of a white screen of the device for Gamma debugging;
obtaining target brightness values corresponding to different gray levels according to the maximum brightness determined; and
adjusting the display brightness of the device for Gamma debugging to the preset brightness according to the target brightness values corresponding to the different gray levels.

14. The method for Gamma debugging of claim 13, wherein obtaining the target brightness values corresponding to the different gray levels according to the maximum brightness determined comprises:
calculating the target brightness values corresponding to the different gray levels according to a gray level, a Gamma value, a relationship formula between the Gamma value and the gray level, and the maximum brightness determined.

15. The method for Gamma debugging of claim 13, wherein adjusting the display chromaticity of the device for Gamma debugging comprises:
obtaining a chromaticity coordinate of the white screen of the device for Gamma debugging;
determining a distribution of the chromaticity coordinate corresponding to the gray level in a color space;
determining, according to the distribution of the chromaticity coordinate corresponding to the gray level in the color space, a color that affects a white coordinate; and
adjusting a chromaticity corresponding to the gray level according to the color that affects the white coordinate.

16. The method for Gamma debugging of claim 12, wherein adjusting the display chromaticity of the device for Gamma debugging comprises:
obtaining a chromaticity coordinate of a white screen of the device for Gamma debugging;
determining a distribution of the chromaticity coordinate corresponding to a gray level in a color space;
determining, according to the distribution of the chromaticity coordinate corresponding to the gray level in the color space, a color that affects a white coordinate; and
adjusting a chromaticity corresponding to the gray level according to the color that affects the white coordinate.

17. The method for Gamma debugging of claim 16, wherein determining the distribution of the chromaticity coordinate corresponding to the gray level in the color space comprises:
determining the distribution of the chromaticity coordinate corresponding to the gray level in the color space according to a difference between the obtained chromaticity coordinate of the white screen and a preset chromaticity coordinate of the white screen.

18. The method for Gamma debugging of claim 16, wherein adjusting the chromaticity corresponding to the gray level according to the color that affects the white coordinate comprises:
adjusting a brightness value of the color in the white screen according to the color that affects the white coordinate, and changing a ratio of the color in three primary colors.

19. The method for Gamma debugging of claim 16, wherein the color space comprises a blue area, a red area, and a green area, wherein
the chromaticity coordinate is determined to be in the blue area when an x value of the chromaticity coordinate is less than 0.32 and a y value of the chromaticity coordinate is less than 0.32, and the white coordinate is affected by blue;
the chromaticity coordinate is determined to be in the red area when the x value is greater than 0.32 and the y value is less than 0.55, and the white coordinate is affected by red; and
the chromaticity coordinate is determined to be in the green area when the x value is less than 0.32 and the y value is greater than 0.32, and the white coordinate is affected by green.

20. A non-transitory computer-readable storage medium storing computer-executed instructions which, when executed by a processor of a device for Gamma debugging, cause the processor to carry out actions, comprising:
adjusting a display brightness of the device for Gamma debugging to a preset brightness; and
adjusting a display chromaticity of the device for Gamma debugging.
